(19) United States
(12) Patent Application Publication
(10) Pub. No.: US 2002/0062740 A1
(43) Pub. Date: May 30, 2002

(54) Method and apparatus for continuous extrusion of filter elements

(76) Inventors: Nikolay V. Brukov, St. Petersburg (RU); Joseph L. Schmidt, Brooklyn, NY (US)

Correspondence Address: RONALD & CORNELL, 4901 Cremshaw Court, Raleigh, NC, 27614, US

(21) Appl. No.: 09/966,299

(22) Filed: Sep. 27, 2001

(30) Foreign Application Priority Data
Sep. 28, 2000 (RU) 2000125339
Aug. 10, 2001 (RU) 2171744

(51) Int. Cl. B01D 53/02; B29C 47/38; B29C 47/60; B29C 70/02

(52) U.S. Cl. 96/153; 425/208; 425/378.1; 425/380; 425/467; 264/122; 264/125; 264/211.21

(57) ABSTRACT

A method and apparatus for making filter elements in which a mixture of activated carbon granules and fibers are processed with meltable polymer fibers to form a porous element. The density of the porous structure increases in a direction from the periphery thereof to its center. Also, the article formed by the method using the apparatus.

This invention relates to the field of processing by extrusion. In particular, it relates to a method and apparatus for the continuous extrusion of porous, activated carbon block filter elements.

### BACKGROUND OF THE INVENTION

Traditional extruders for polymeric material processing have had three zones: a) a loading zone with a cylindrical screw core and maximum helical flight height, b) a compression zone with a conical screw core, wherein the flight height is reduced, thereby effecting compression of the processed material, and c) a feed zone wherein the screw core is cylindrical and the flight height is minimum. Such design of the screw ensures intensive softening of the polymer material in the compression zone due to transition of mechanical energy to heat. However, the mixtures that are used for obtaining porous activated carbon based filter elements contain so little amount of the polymer binder that compression, typical for ordinary screws can not be implemented by polymer deformation. Therefore, the attempts to use standard extrusion machines to make porous filter elements have resulted in considerable destruction of the carbon component resulting in formation of over-compacted structures and lock up of the extruder.

The method and design of the extruder for the manufacture of thick walled pipes or large diameter solid rods of polymer materials are described by M L Friedman in “Crystalline Polyolefins Processing Technology”, Publishing House “Chemistry”, Moscow, 1977. The main problem in formation of products with homogeneous structure is the deterioration of material continuity in the course of shrinkage during cooling, so that cavities and pores develop. Friedman teaches to eliminate said defects by using braking method known in the art of extrusion, namely, an application of the preset braking force after the extrusion die to the product which is being manufactured. Thereby, the braking force is transmitted from the product which moves through the cooling zone outlet to the melt, which is located inside the extrusion die and which participates in the product structure formation. Thus, the replenishment by the fresh melt compensates for shrinkage of the extruded product and provides required longitudinal and lateral homogeneity of the interior structure. However, the design elements of the traditional die, including using the braking, do not allow the use of a traditional die effectively to process the mixtures for making porous activated carbon block filter elements. The reasons are the reduction in the junction between the interior of the extruder barrel to the extrusion die inlet (head junction), as well as formations built up at the place of fixture of the mandrel inside the extrusion head matrix, which over-compacts and wedges the mixture.

Known in the state of art are extruders for the manufacture of rod or block elements comprised of a binding polymeric material and a basic material, such as carbon. Extrusion apparatus for manufacturing carbon containing rods out of a mixture of basic material and binder is disclosed in U.S. Pat. No. 4,025,262 dated May 24, 1977. It comprises an extruder screw positioned inside an expanding barrel. The mixture containing powdered carbon and binder is fed into the barrel, and then it moves to an extrusion head of permanent cylindrical configuration to mold the mixture, which is released therefrom. In addition, the apparatus comprises a barrel heating facility and means connected to the screw to actuate its movement. The control gear is provided for manual or automatic regulation. The length of the extrusion head mobile die may be regulated by the control gear. The die length regulation is described as a function of the hydraulic clamping forces required to maintain the mobile position of the die. As the mixture contacts the head die surface the length regulation may also be provided by the screw axial movement. If the screw has constant depth and spacing of the spiral flights, local over-compaction of the extruded material due to delay or an obstacle to material movement, there may be material lock up. The manufacture of products in the described extruder apparatus stipulated by the periodicity of the undertaken extrusion process does not allow to obtain products with uniform lengthwise density. There is a lack of opportunity to control the product structure formation conditions due to inability to completely control friction in hydraulic joints.

A method and apparatus for continuous extrusion of solid porous products eliminating the obstacle making difficulties are described in the U.S. Pat. Nos. 5,189,092 and 5,249,948. A mixture of the basic material and powdered polymeric binder, e.g., 85% activated carbon and 15% polyethylene, are fed to the mixer, thereafter the homogeneous mixture comes to the loading hopper and then to the barrel. The apparatus consists of the barrel with an extrusion screw and an elongated smooth extrusion head (die) connected with the barrel end. The screw comprises the rigid core mounted by spiral flights. In case of making hollow solid products a mandrel can be connected to the screw core along its axis. Exiting the barrel the mixture is passed through the cylindrical die of permanent cross section less than the cross section of the inner diameter of the barrel. To make hollow products, the mandrel is envisaged in the extrusion head, the said mandrel being positioned axially to the screw core. Heating with compression inside the die is applied, so that the mixture is converted to homogeneous material. The mixture is heated with the help of heating elements to the temperature exceeding the melting point of the binder, but less than the destruction temperature of the basic material. Subsequently, cooling is undertaken. A solid block is obtained in the result, to which back (braking) pressure is applied. To prevent particles from grinding and crumbling-out the pressure should be precisely regulated. The key of the invention according to the U.S. Pat. No. 5,189,092 is the maintenance of the extrusion pressure in the die. To obtain porous filter elements it is possible to use a standard design extrusion apparatus for traditional plastics manufacturing, which may have length to diameter ratio of 10:1 and be equipped with bimetallic material cylinder for protection against the abrasive effect of powder or particles. The cylinder is designed to withstand high pressure. The extrusion head cross section may be not much less than the free area of the screw cross section (the free cross section area is the area or volume of the loaded material limited by the space between the screw core and the screw flight turns corrected for the flight thickness). When activated carbon is used as the active material, difficulties may arise, being caused by wedging of the material as the material moves from the barrel outlet to the extrusion head inlet. These problems can be eliminated by using a flared flange to connect the barrel with the extruder head. To provide for expansion of the material at the head inlet the back pressure is required, which is applied with the help of the braking device.

One of the disadvantages of devices designed for the continuous extrusion of filter elements such as those disclosed in U.S. Pat. Nos. 5,189,092 and 5,249,948 is the uncontrollable braking axial force which develops as the material moves through the elongated extrusion head due to the location of the screw only in the cool zone, which hinders the ability to control the density of the porous structure of the filter elements (the main heaters are located in the extrusion head). Besides, since the flights of the short screw are of permanent height and width, there is helical over-compacted zone with high hydraulic resistance that is formed on the interior surface of the filter element. This over-compacted structure is formed under conditions of intensive grinding and size downgrading of carbon particles, which contact the front walls of screw flights at high pressure.

It is believed that the closest known analogue to the claimed method and apparatus are the method and apparatus for continuous extrusion of porous activated carbon block filter elements formed from a mixture of premixed granular or powdered activated carbon and powdered binding polymeric component is described by U.S. Pat. No. 5,976,432, dated Feb. 11, 1999. The extrusion apparatus comprises a hopper with vertical auger and a mixture in a form of thoroughly premixed components, for example, powdered polyethylene and powdered or granular primary material, e.g., activated carbon. The hopper leads to the cylindrical barrel. The barrel is positioned along the longitudinal axis; it comprises means for feeding and discharging the mixture. The screw, equipped with traditional helical flights on the core, is positioned inside the barrel coaxial to it along its entire length. The screw core diameter increases gradually along the downstream flow. The screw end is narrow so that the core diameter is abruptly reduced. This screw core diameter reduction is required to build up a zone of greater volume of heated material in front of the junction between the barrel and the extrusion head. Helical flights end in the narrowed butt of the screw by the surface perpendicular to the longitudinal axis of the screw. The cylindrically shaped extrusion head is connected with the discharge end of the barrel and it is positioned along the longitudinal axis adjacent to the barrel. The mandrel is housed inside it and is connected to the narrowed end of the screw. The water cooling jacket is positioned at the extrusion head exterior surface, wherein the water temperature is to be lower than the melting point of the polymeric binder. The cooling tunnel is positioned after the extrusion head. The pressure in the extrusion head is controlled with the help of the control device, providing stable exit of the block from the extrusion head. In operation of the apparatus described in U.S. Pat. No. 5,976,432, a premixed material of activated carbon and binding component, e.g. polyethylene, is fed to the hopper at room temperature. At slow velocities the vertical screw moves the mixed material from the hopper into the barrel. The screw moves the mixture along the barrel to the narrowed end of the screw, while the material is heated. Due to heating the binding component softens, partly melts and starts to form bonds among carbon granules until the mass exits from the barrel. The increasing diameter of the screw core compresses the advancing mixture. This mass comes into the extrusion head, it gets partly compacted there, and it is formed into the extruded element. This extruded element passes through the cooling tunnel for the final strengthening of the product. The performance of this type of extrusion apparatus is adversely affected because the material is still over-compacted due to the narrower helical flight channel extending from the loading zone to the extrusion head. Consequently, these conditions provoke lock up of the mixture in the barrel and formation of hydraulically impervious zones in the filter elements. Further down in the extrusion head due to the mandrel is rigidly fixed to the screw and, as it rotates, surface of the material is ground away and destroyed. The resulting dust fraction clogs the pores between particles, facilitating higher hydraulic resistance of the filter element during use.

Significant disadvantages of filter elements obtained in accordance with the above described prior art methods include insufficient service life and high hydraulic resistance. It is due to the fact that the pore sizes of the filter elements are the same across the wall thickness. The pores' sizes are characterized by the equivalent diameters. Thereby, the contaminant particles, which are larger than the equivalent diameter of pores, are mostly retained at the exterior surface of the filter, forming a poorly permeable layer of particles of various sizes. The filter service capacity can be determined according to the total amount of contaminant particles that can be stopped by the filter while preserving an acceptable level of hydraulic resistance. On the other hand, the filtration characteristic of the filter is determined by the minimum size of the particles retained by the filter and, correspondingly, an equivalent pore size. Therefore, the desire to have porous material with homogeneous properties leads to lower filter life capacity and unjustified increase of the hydraulic resistance of the filter. The reason is that the pores of the in-depth layers of the filter wall practically are not involved in the process of filtering the contaminant particles that have been already stopped at the exterior surface of the filter.

### OBJECTS OF THE INVENTION

The main objectives of the present invention are the development of a new method and apparatus for the continuous extrusion of porous filter elements made of a mixture of activated carbon fibers, granular activated carbon, and a polymeric binder which can be in form of fibers, a mixture of fibrous polymers, or a mixture of fibrous and powdered polymers.

The objectives of the invention include the technical advantages of producing a filter having longer service life and lower hydraulic resistance, while retaining high quality filtering properties and mechanical strength.

### BRIEF DESCRIPTION OF THE INVENTION

The required technical result is achieved by using the herein disclosed and claimed apparatus to perform the claimed method of continuous extrusion of filter elements made of activated carbon material and polymeric binder. The method described and claimed herein comprises mixing the components, loading the mixture in solid state into the barrel, moving the mixture through the barrel at the screw rotation velocity while heating the mixture in the barrel above the melting point of the polymeric binder, moving the mixture from the barrel outlet end into an extrusion head, forming the porous filter elements under the braking force effect, and subsequently cooling them below the melting point.

Mixing of the components may be effected in two stages. The activated carbon material may comprise activated carbon fibers and granular activated carbon with the ratio of components 1:100 to 20:100 by weight. The porous structure is formed prior to the stage of moving the mixture from the barrel outlet end into the extrusion head. The filter density is thereby increased across the thickness of the porous structure in the direction from the periphery to the center of the filter. The porous structure formation takes place in the zone of variable clearance between the screw flights and the interior surface of the barrel with the subsequent advance of the formed structure along the clearance between the divergent conical surfaces of the facility connecting the barrel end with the extrusion head. The possibility of retaining the formed structure in the clearance is provided. The formation of the porous element is undertaken with the extrusion head mandrel rotating at a slower speed than the screw; more specifically, the extrusion head mandrel will rotate at a velocity of from 0.001:1 to 0.99:1 (preferably from 0.001:1 to 0.05:1) of the screw rotation velocity. Thereby, at the first stage of mixture preparation, granular activated carbon and polymeric binder are mixed with intensive agitation. At the second stage, the activated carbon fibers are introduced into the mixture prepared at the first stage, with agitation at a rate less that the agitation rate at the first stage.

The polymeric binder should be at least partially in fibrous form, and can be a single fibrous polymeric material, a mixture of fibrous polymers, or a mixture of powdered and fibrous polymers. The use of binder in the form of fibers makes it possible to increase the weight percent of useful activated carbon. It also helps to reduce flow resistance. Preferably, activated carbon fibers with a 2 to 100 (preferably 5 to 20) ratio of fiber length to fiber diameter are used. The polymeric binder is advantageously used in the form of a mixture of fibrous polymers with a melting point of one of the polymers differing by at least 10° C. from the melting point of the other. Alternatively, the polymeric binder employed can be a mixture of powdered and fibrous polymers with the melting point of the powdered polymer being below the melting point of the fibrous polymer. The preferable ratio of the fiber length to fiber diameter of the polymeric binder may be 2 to 100, preferably 5 to 20.

The apparatus for the continuous extrusion of filter elements comprises means for loading the mixture and a barrel with means for moving the mixture communicating with the means for loading the mixture. It also comprises a screw equipped with helical flights on a core with the core being positioned co-axially with the barrel along its entire length, barrel heaters, an extrusion head which is connected with the barrel outlet end and positioned along the longitudinal axis adjacent to the barrel, and a mandrel attached to the end of the screw.

In accordance with the invention, the apparatus additionally comprises means connecting the barrel outlet end with the extrusion head, wherein a tapered reduction means connecting the barrel to the extrusion head are made with displacement toward the extrusion head in relation to the tapered reducer connecting the screw core to the mandrel. The angle of the conical surface of the outer reducer connecting the barrel to the extrusion head is greater than the angle of the conical surface of the inner reducer from the screw core to the mandrel. The helical flights of the screw are made with gradual reduction of the flight width in the direction of the mixture discharge towards the extrusion head, wherein the spacing between the neighboring front walls of the screw flight is less than the spacing between the corresponding rear walls of the same flight. The mandrel is attached to the screw core in such a way that it has a possibility of free rotation relative to the screw. Thereby, the interior surface of the barrel has round or oval shape cross section and the cylindrical screw core has the same diameter along the entire length.

The description below will show, with more details, that the present invention allows to obtain porous filter elements with improved functional properties.

### BRIEF DESCRIPTION OF THE DRAWINGS

The nature of the invention is explained with reference to the following drawings in which:

FIG. 1 is a longitudinal cross sectional view of the apparatus for the continuous extrusion of filter elements;

FIG. 2 is a longitudinal cross sectional view of the screw of the apparatus of the invention; and

FIG. 3 is a longitudinal cross sectional view of the means connecting the barrel outlet end with the extrusion head.

### DETAILED DESCRIPTION OF THE INVENTION

The apparatus is designed for the continuous extrusion of porous filter elements from a mixture of activated carbon fibers, granular activated carbon and polymeric binder, at least a portion of which will be in the form of polymer fibers. The polymeric binder can be comprised of a single polymer in fibrous form, a mixture of two or more different fibrous polymers, or a mixture of powdered and fibrous polymers. For example, suitable polymeric materials can be polypropylene, polyethylene or a polyamide.

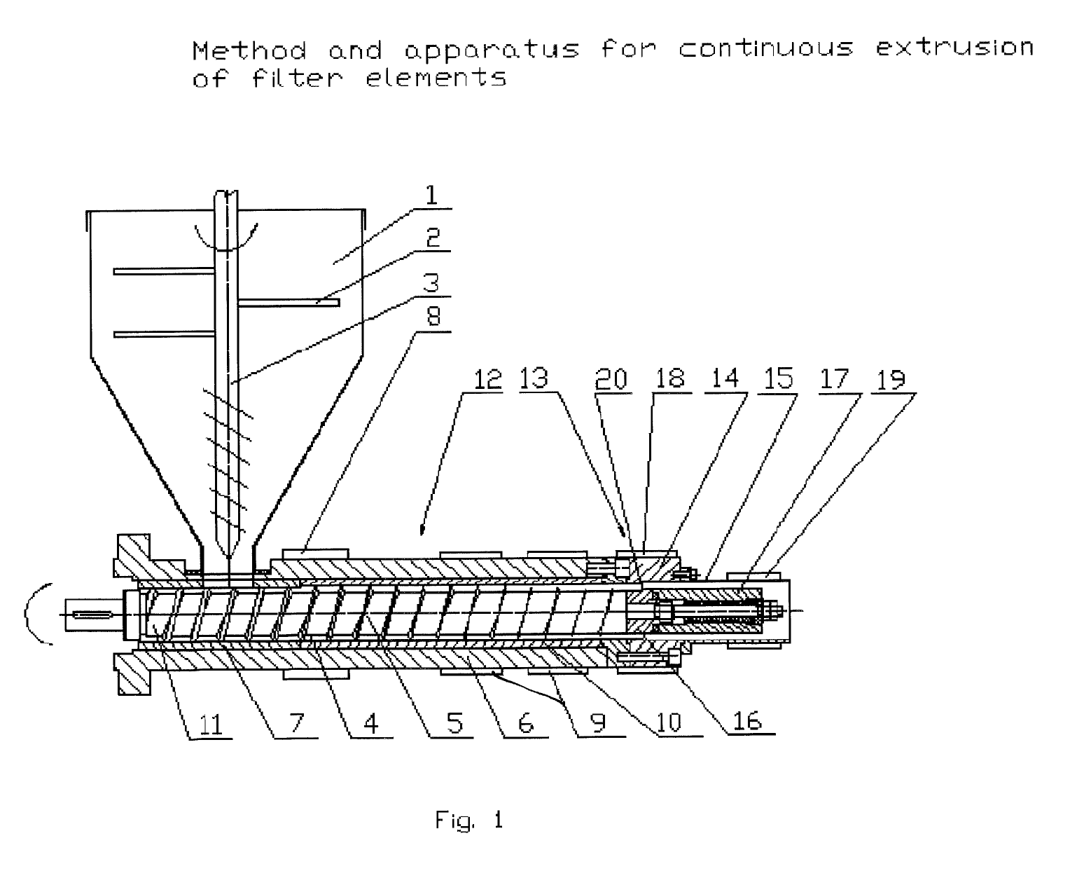

Referring now to FIG. 1, the apparatus comprises a hopper 1 which is equipped with an agitator 2, allowing to prevent the overhang formation of granular and powdered materials, and a loading auger 3 for forcibly feeding the processed mixture into loading zone 7 of the helical screw 5 positioned inside the barrel 6. The interior surface of barrel 6 has a round or oval shaped cross section. To reduce slippage and thereby improve the transportation capacity of the screw 5, the barrel 6 is equipped with a sleeve 10 having longitudinal corrugations.

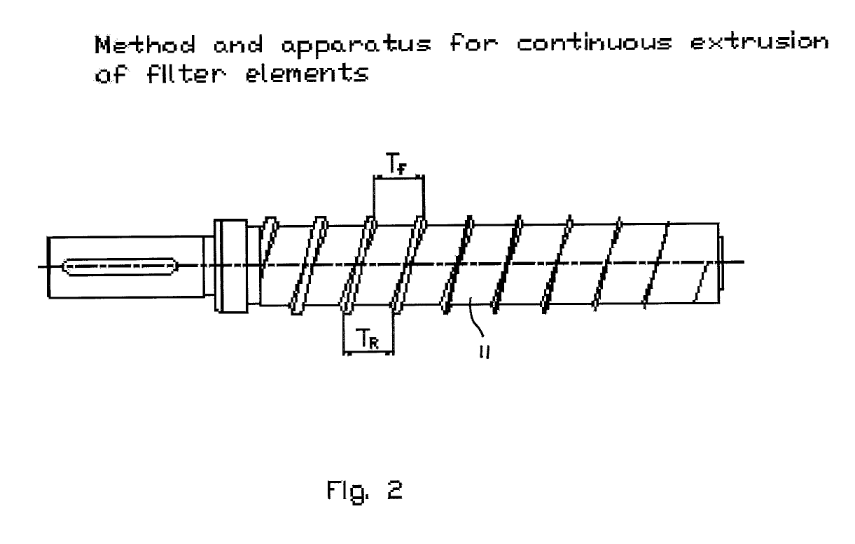

There is a cooling jacket 8 in the loading zone 4 of the barrel 6 which is used to prevent possible overheating and sticking of polymeric binder to the screw flights. Downstream zones of the barrel 6 are heated to preset temperatures with the help of one or more heaters 9. To lower the degree of wear, the barrel is lined with a sleeve 10 made of wear resistant material such as hardened tool steel which has been heat treated or nitrated {Rockwell Hardness greater than about 56). The cylindrical core 11 of the screw 5 (FIGS. 1 and 2) has a constant diameter along its length, and the thread of the front and rear walls of the screw flights is manufactured with variable spacing, whereby the spacing of the front wall of flight T_{f} (FIG. 2) is less than the spacing of the rear wall T_{R}. As a result, moving by one step of the flight along the screw axis from the loading zone towards the molding tool, the screw flight width is decreased by ΔT=T_{f}−T_{R} and, at the same time, the screw interior width between the flights is increased by the same value. Therefore, the gradual flight width decrease results in a simultaneous continuous increase of the volume of the single screw turn.

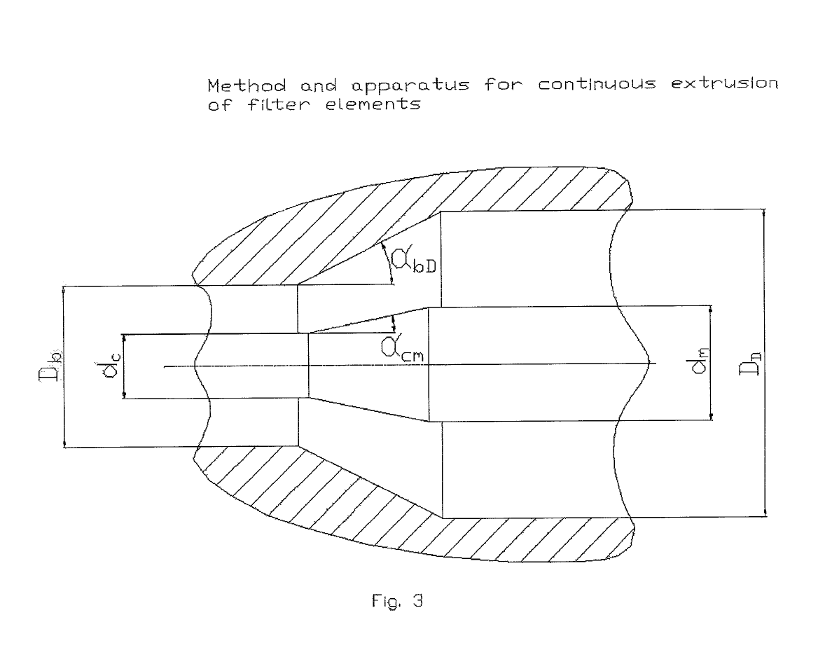

An extrusion head 13 is attached to the outlet of extruder 12. The molding tool-extrusion head 13 comprises a die 14, a calibrator 15, a splitter 16 and a mandrel 17. Predetermined temperature conditions are maintained in the die 14 with the help of heater 18. The design of the mandrel attachment to the screw permits the mandrel 17 to rotate at a velocity different from the rotation velocity of the screw 5, which prevents the wear out and destruction of the surface of the molded filter element. The mandrel 17 may be fixed to the screw core with the help of a suitable axial connection means providing the possibility of free rotation in relation to the screw. The die 14 with diameter D_{D} determines the exterior surface of the filter element whereby D_{D} is greater than the barrel opening diameter D_{b}. Splitter 16 and mandrel 17 with outer diameter dₘ fixed at the end of screw 5 determine the interior surface of the filter element, whereby dₘ is greater than diameter d_{c} of the core 11 of the cylindrical shaped screw 5. Enlarging transitions from D_{b} to D_{D} and from d_{c} to dₘ are made along the divergent conical transition surfaces of the means 20 connecting the corresponding surfaces. Thereby (as shown in FIG. 3) the tapered wall enlarges from D_{b} to D_{D} in the direction of the outlet from the barrel towards the extrusion head with the taper starting before and finishing after the tapered enlarging piece d_{c} to dₘ. In addition, the angle α_{bD} of the conical surface of the D_{b} to D_{D} means is greater than the angle α_{cm} of the conical surface of d_{c} to dₘ. This changing geometry of the connecting means 20 makes it possible to retain the filter material structure of the finished product with increasing density across its cross section as it moves through said connecting means. The product shape is secured by cooling in calibrator 15 and on mandrel 17. Cooling is performed with the help of the liquid coolant flowing at predetermined temperature through cooler 19.

The apparatus functions and the method are implemented as follows: Granular activated carbon and polymeric binder in a form of fibers with a fiber length to diameter ratio of 2 to 100, and preferably 5 to 20, or in the form of a mixture of fibrous polymers, or in a form of a mixture of powdered and fibrous polymers (with the same fiber length to diameter ratio), for example, polypropylene, polyethylene or polyamide (nylon), are mixed in the turbulent four-blade mixer. The mixing proceeds with intensive agitation. Then activated carbon fibers with fiber length to diameter ratios between 2:1 and 100:1, preferably 5:1 and 20:1, are added to the mixer, wherein the ratio of the activated carbon fiber to the granular activated carbon shall be 1:100 to 20:100 by weight. The second stage of mixing is undertaken with agitation at the rate less than the agitation rate during the first stage. The obtained mixture is loaded into receiving hopper 1 wherefrom with the help of agitator 2 and loading auger 3 the processed mixture is forcibly fed through the loading opening 4 into the barrel 6. The mixture is successively heated with the help of heaters 9 to temperatures of 130° C. and 180° C. in two heated zones of the barrel as it moves with the help of the screw 5 along barrel 6.

Any excessive moisture contained in the activated carbon material is removed from the barrel during the initial stage of the mixture movement. Subsequently, due to the heat transfer from the barrel walls to the transported mixture, the polymeric binder is softened and at least partially melted.

Movement of the mixture by the screw 5, with gradual reduction of the flight width towards the extrusion head 13 (with the flight front wall spacing less than the rear wall spacing) causes redistribution of the packing density of the activated carbon fibers in gaps (pores) among the granular activated carbon particles due to the intensive alteration of the dimension and shape of the pores. The maximum packing density of the activated carbon fibers takes place at places where the pores are the smallest, forming densely compacted clumps. On the other side, in places where the pores are the largest, the packing density of the activated carbon fibers is sharply reduced forming thinned zones. Thus, a porous structure is formed with intercalating zones of the dense and thin clumps of the activated carbon fibers among the granular activated carbon particles. This can be characterized by various values of the equivalent diameter of filtering pores (ducts). It should be noted that if the ratio of the activated carbon fiber to the granular activated carbon is less than 1:100, the tightly knit bunches (clumps) do not form through the entire volume of the mixture, and at a ratio over 20:100 excessive over-compaction of the thinner zones takes place. The most compacted bunches of activated carbon fibers provide the smallest channels for the flow of liquid, thus providing the required degree of purification in the filter element. On the other hand, large clearances (gaps) between the activated carbon fibers in the less compacted zones provide for substantially lower hydraulic resistance. As a result, walls of the filter element wall comprise interconnected channels with varying hydraulic resistance. The total combined resistance of a filter element having a channel structure made in accordance with this invention will be less than that of filter elements comprised of sintered powdered particles which provide a product having channels with substantially constant equivalent diameters and uniform packing density, the value of which is determined by the minimum size of filtered contaminant particles and, consequently, the preset purification degree of the filter element.

The required mechanical strength of the above described structure is obtained due to the presence of polymeric binder fibers; which are at least partially fused into tightly knit bunches with activated carbon fibers. Said polymer fibers penetrate through the thinner zones.

If a mixture of fibrous and powdered polymer mixture is used as the polymeric binder there is an additional opportunity to bind difficult to melt thermoplastic or non-melting thermosetting polymeric fibers with activated carbon material due to presence of a powdered polymer with sufficiently low melting point. Using a mixture of fibrous polymers whose melting points differ by less than 10° C. does not allow to prevent melting of the more difficult to melt component because the process of the transition of mechanical energy into heat is hard to control. The resulting heterogeneous structure has minimum hydraulic resistance and provides the required minimum equivalent diameter of the pores and the required mechanical strength.

The upper limit of the length to diameter ratio of the present fibrous components determines the maximum permissible length of fibers that do not clot into the strong agglomerates. If the length to diameter ratio of the fibrous components is less than the stated lower limit, there will be no formation of the required intercalating thinner zones and tightly knit bunches of activated carbon fibers bound with polymer fibers.

The mixture is subsequently moved to a zone of variable clearance between the flights of the screw 5 and the interior surface of barrel 6 wherein the porous structure is formed. Said porous structure's density increases in the direction from the periphery towards the center. The gradual reduction of the flight width of the screw 5 with the trapezoidal shape leads to the formation of the screw zone where the flight section shape converts to the triangular shape, and, thereby, the flight height is reduced towards the barrel outlet.

As the screw flight height is reduced, also reduced is the area of the contact of the screw flight front wall, which is responsible for moving the mixture towards the extruder head. Consequently, the pressure, which develops on the contact surface and which is required to overcome the applied braking force, rises. So there exists unambiguous interrelation of the screw flight height, or the distance to the screw core surface and the pressure at which the porous structure is formed. Higher pressure, at which the porous structure is formed, causes higher density of the porous structure. Hence, the density of the porous structure at any point in the layer equidistantly remote from the core surface is also the same. Therefore, due to the gradual reduction of the flight width in the direction toward the extrusion head with the spacing of the flight front wall being less than the rear wall spacing, the porous structure is formed from the layers with constant density. Thereby, the density of the layered porous structure increases in the direction from the periphery to the center and is maintained equal in the axial direction. Higher density at micro-level leads to the smaller equivalent diameter of pores and to the smaller particle size of contaminants which can be caught by the filter with this porous structure. As a result, the porous structure of the in-depth filter is formed, wherein different size contaminant particles are filtered at different distances from the exterior surface in the direction from the periphery to the center of the cylindrical filter element. Also, the smaller the size of the retained contaminant particles, the deeper they penetrate into the filter element wall. Thus, in the course of the filter element operation the retained contaminant particles become distributed across the filter element wall thickness, which allows to increase the total quantity of the contaminant particles retained by the filter element, provided that the hydraulic resistance acceptable for operation is preserved; as a result, the filter element service life may be extended.

The formed porous structure leaves the barrel and passes through the divergent gap (clearance) between the conical surfaces of the means 20 connecting the barrel 6 and the extrusion head 13, it allows to retain the structure of the finished product. The filter element is formed in the extrusion head 13 where the rotation velocity of the mandrel 17 is less than the rotation velocity of the screw 5, under cooling with the help of the liquid coolant flowing through the cooler 19 at a temperature below the melting point of the polymeric binder. The obtained filter element may be finely cooled by air blowing or natural convection.

Difference in velocities of the screw and the mandrel make it possible to form the element with a porous structure wherein the thin layer adjacent to the surface of the mandrel contains a lower amount of the dust fraction which is formed due to grinding and wear off of the activated carbon components as compared to the result from the intensive rubbing against the surface of a mandrel which is rigidly connected to the screw and rotating at great angular velocity. This allows to prevent higher hydraulic resistance in the above described layer of the filter element.

To prove the possibility of the industrial applicability of the method and apparatus of the continuous extrusion of porous filter elements below is an example of the implementation of the invention.

### EXAMPLE

55 parts by weight of granular activated carbon (Calgon Carbon Corp., 80×235 mesh, USA) and 10 parts by weight of shredded polypropylene fiber (technical spun tread, 83.5 tex, Kurskkhimvolokno Co., Kursk, Russia, shredded, having fiber lengths to diameters ratio of about 10 to 15) are mixed in a turbulent four-blade mixer for 4 minutes at 500 rpm. The polypropylene fibers have a melting point of 160-170 degrees C. The fiber diameters range from about 10 to 20 microns, and their lengths are from about 200-1000 microns. These fibers have an MPI (Melt flow Index) of 1-5 gram/10 minutes.

Then activated carbon fibers (fiber length to diameter ratio 10 to 15) in an amount of 10% of the weight of the granular activated carbon are added to the mixer. This corresponds to an activated carbon fiber to granular activated carbon ratio of 10:100 by weight, and the second stage of mixing is performed for 1 minute at 200 rpm. The activated carbon fibers are manufactured by Aquaphor Corporation, St. Petersburg, Russia by the method described in U.S. Pat. No. 5,521,008.

The obtained mixture is loaded into receiving hopper 1. The mixture is fed through loading hole into barrel 6. The mixture is moved by screw 5, rotating at 15 rpm velocity, along barrel 6 and is heated in two heating zones of barrel 6 with the help of heaters 9 to temperatures of 130° C. and 180° C., then it is transferred to the variable clearance (gap) zone between the flights of screw 5 and the interior surface of barrel 6 wherein the porous structure is formed so that its density across its width in the direction from the periphery to the center. The spacing of the screw flight front wall is 29.5 mm. The spacing of the screw flight rear wall is 30 mm. The screw diameter is 59 mm.

The molded porous structure leaves barrel 6 and passes through the clearance between divergent conical surfaces of the connecting means 20 connecting the discharge end of the barrel 6 with the extrusion head 13, wherein the structure of the finished product is preserved. The angle of the conical surface of the reduction piece connecting the screw core to the mandrel is 10°, and the angle of the part connecting the conical surface of the barrel to extrusion head die is 15°. The displacement of the start and end of the screw core to mandrel reduction piece conical surface in relation to the barrel to extrusion head die reduction piece conical surface is 0.5 mm. The filtration element formation within the extrusion head 13 takes place at the 0.1 rpm rotation velocity of the mandrel 17 (which corresponds to the ratio of the mandrel rotation velocity to the screw rotation velocity 0.0066) under cooling with the liquid coolant (at 80° C. temperature, which is less than the polypropylene melting temperature of 166° C.) flowing through the cooler 19. Finally, the filter element obtained thereby is cooled by air which is passed thereover. The filter elements have a mean density 0.73 g/cm in the longitudinal direction, and in the lateral direction the density varies from 0.61 g/cm³ on the exterior surface to 0.79 g/cm³ on the interior surface.

The filter elements were tested with the drinking water purification system at 2.5 L/min capacity. The filtration capacity of the filter element of the present invention for purifying organic additives is at least 6000 liters with a purification degree of at least 99.9%. In contrast, the filtration capacity of a comparably sized filter element for purifying water from organic additives made by US FILTER (Product certificate CCBC-10,1999, US Filter, Plymouth Products, USA) is only 5000 liters.

Tests of filter elements manufactured according to the present invention comprising composite polymeric binder and the activated carbon materials, retaining the same ratio of mixture of binder with the activated carbon materials, wherein there is used, for example, a mixture of the above polypropylene fibers with polyethylene fibers having a melting point of about 120-130° C., monofiber diameters of from 10-20 microns, fiber lengths of 200-1000 microns, and an MFI of 0.3-3 g/10 min.; and also, for example, a mixture of said polyethylene fibers with polyamide (nylon) fibers having a melting point of 210° C., diameters of 20 microns, fiber lengths of from 100-400 microns; and also a mixture of said polypropylene fibers and powdered polyethylene having a melting point of 120-130° C., and an MFI of 0.3-3 g/10 min. all provide results substantially identical to the above given example.

The filter elements obtained by the present invention may be used in filters and filtration systems designed to purge liquid and gaseous media of organic admixtures, chlorine, colloid particles, e.g., iron hydroxide and bacteria, in particular for water purification, e.g., drinking water and air.

What is claimed is:

1. In a method for making filter elements comprising mixing activated carbon and polymeric binder; extruding the mixture at a predetermined velocity through an extruder barrel, heating the mixture in the barrel to a temperature above the softening point of at least some of the polymeric binder, molding the mixture into a porous element, and cooling said porous element below the melting point of the polymeric binder; the improvement comprising increasing the density of the porous structure in a direction from the periphery thereof to the center of the structure and then removing the mixture from the discharge end of the extruder.

2. The method of claim 1 wherein at least some of the polymeric binder is introduced in the form of fibers.

3. The method of claim 2 wherein, in a first step the granular activated carbon and the polymeric binder are mixed with intensive agitation, and then the activated carbon fibers are introduced and mixed with less vigorous agitation.

4. The method of claim 1 wherein the density of the porous structure is variably increased by moving the molded structure forward in the extruder using a predetermined screw rotation velocity, and then passing the porous element through an extrusion head having a mandrel which operates at a rotation velocity lower than the screw rotation velocity.

5. The method of claim 4 wherein the mandrel rotation velocity is from 0.001-0.99 times the screw rotation velocity.

6. The method of claim 1 wherein the polymeric binder is introduced in the form of a mixture of fibrous polymers.

7. The method of claim 6 wherein the polymeric binder is a mixture of fibrous polymers of at least two different polymeric compositions, with the melting point of one type of polymer differing by at least 10° C. from the melting point of the other.

8. The method of claim 1 wherein the polymeric binder is introduced in the form of a mixture of powdered and fibrous polymers.

9. The method of claim 8 wherein the melting point of the powdered polymer is lower than the melting point of the fibrous polymer.

10. The method of claim 1 wherein the polymeric binder comprises a material selected from the group consisting of polypropylene fibers, polyethylene fibers and polyamide fibers.

11. A method of claim 10 specified by the use of fibrous polymeric binder having an average fiber length of about 5 to 20 times the average fiber diameter.

12. The method of claim 1 wherein the activated carbon fibers have an average length of about 2 to 100 times the average fiber diameter.

13. Apparatus for the continuous extrusion of filter elements from a mixture of activated carbon material and polymeric binder comprising an extruder barrel having an inlet and a discharge end, means to feed the mixture into said inlet, a screw within said barrel positioned coaxial to the barrel and being comprised of a core having helical flights thereon, means to control the temperature within said barrel, an extrusion head, and means connecting the discharge end of the barrel with the extrusion head, with the extrusion head being positioned along the longitudinal axis of and adapted to receive material from the discharge end of the barrel, said connecting means comprising a generally conically expanding inner wall that connects the barrel to the extrusion head, and a mandrel fixed to the screw, said mandrel comprising a generally conically expanding outer wall positioned inwardly of the conically expanding inner wall of the connecting means.

14. The apparatus of claim 13 wherein the helical flights of the screw are formed with a gradual decrease of the flight width in the direction of the discharge end of the barrel, said decrease being provided by having the spacing between the front wall of adjacent helical flights less than the corresponding rear wall spacing.

15. The apparatus of claim 13 wherein said mandrel is adapted to rotate freely with respect to rotation of the screw core.

16. The apparatus of claim 13 wherein the interior surface of the barrel has a circular cross section.

17. The apparatus of claim 13 wherein the interior surface of the barrel has an oval cross section.

18. The apparatus of claim 13 wherein the diameter of the screw core is constant along its the entire length.

19. The apparatus of claim 13 wherein the angle of the conical surface of the generally conically expanding inner wall of said connecting means is greater than the angle of the generally conical outer surface connecting the screw core to the mandrel.

20. A filter element comprising of activated carbon fibers, activated carbon granules and polymeric binder; wherein the density of the porous structure increases in a direction from the periphery thereof to the center of the structure.
